(19) United States
(12) Patent Application Publication
(10) Pub. No.: US 2016/0338336 A1
(43) Pub. Date: Nov. 24, 2016

(54) METHOD AND APPARATUS FOR VERMIN TREATMENT

(71) Applicant: Willaim George Aylett, Cranbourne (AU)

(72) Inventor: William George Aylett, Cranbourne (AU)

(21) Appl. No.: 15/112,927

(22) PCT Filed: Jan. 20, 2015
(86) PCT No.: PCT/AU2015/000023

§ 371 Date: Jul. 20, 2016

(30) Foreign Application Priority Data
Jan. 20, 2014 (AU) 2014900165

(51) Int. Cl. A01M 13/00; A01M 17/00

(52) U.S. Cl. CPC A01M 13/006; A01M 17/004

(57) ABSTRACT

A method of euthanizing air-breathing animals by replacing part of their air supply with the exhaust emissions of an internal combustion engine. The engine is mounted on a barrow that can be wheeled to the burrows of rabbits, gophers and the like. The engine runs initially on a lean fuel/air mix and later on extra fuel that raises the oxides of carbon content to 6%. The inclusion of fogging oil makes the emissions visible so that the operator is able to avoid breathing them. The emissions can be directed into chambers for euthanizing collected animals such as hens and scaled up in order to treat large volume areas such as grain silos in order to kill silo vermin.

### CROSS-REFERENCE TO RELATED APPLICATIONS

This application is a national phase entry under 35 U.S.C. §371 of International Patent Application PCT/AU2015/000023, filed Jan. 20, 2015, designating the United States of America and published in English as International Patent Publication WO 2015/106312 A1 on Jul. 23, 2015, which claims the benefit under Article 8 of the Patent Cooperation Treaty to Australian Patent Application Serial No. 2014900165, filed Jan. 20, 2014.

### TECHNICAL FIELD

This application concerns a method and apparatus for the destruction of air-breathing vermin and livestock.

### BACKGROUND

Vermin have traditionally caused considerable damage to economies all over the world. To the loss of food that is eaten must be added the food that is contaminated and, therefore, rendered unsaleable or downgraded. Some animals and birds carry infectious diseases that affect people. Birds in poultry houses may show signs of disease that regulations demand must be reported and, in order to isolate the outbreak, the birds are destroyed. These realities present problems to people who earn their living on the land, one of which is how to euthanize the target animals.

It is known to use poisons in the form of bait, an example being metal phosphides and organic fluoro compounds. The bait, such as cyanamidic compounds, is put into plastic sachets that are discovered by rodents and chewed.

Burrowing animals may be reached by releasing into the burrow the vapor generated by heating a liquid fumigant. A container of phosphine gas may be discharged into a burrow. Alternatively, the burrow is filled with injected foam to remove the vermin's air supply. Insects are dealt with by releasing chlorine from a chlorine compound through the addition of water.

U.S. Patent Publication No. 2012/0266521 describes a device for intercepting the exhaust gas from a car silencer and directing this into a burrow, adding dry ice to increase the toxicity of the exhaust gases.

### BRIEF SUMMARY

One aspect of the disclosure provides a method of euthanizing air-breathing animals that includes the step of raising the concentration of carbon monoxide in their air supply by at least partial replacement of the air supply with the exhaust emissions of an internal combustion engine.

In another aspect of the disclosure, there is provided a mobile apparatus for the destruction of air-breathing vermin comprising a trolley, an internal combustion engine supported on the trolley with an exhaust system operable to direct a stream of engine exhaust gas into a treatment site, a hydrocarbon fuel reservoir that is a portable gas tank for liquefied hydrocarbon gas, a conduit for connecting the system to the treatment site, wherein the mobile apparatus further includes a carbonation device that increases the oxides of carbon content in the exhaust gases by adding hydrocarbon fuel beyond the level required to run the engine to make the emissions visible at the treatment site.

The exhaust gas may be cooled by passage through a heat exchanger placed in series with the engine exhaust. The aim is to ensure that there is no undue rise in temperature if the exhaust gas is filling up a site of small volume like a burrow. The aim is to ensure the target animal dies quickly only of carbon monoxide poisoning and not physical trauma.

The method, therefore, includes the step of selectively admitting to the fuel arriving at the engine a hydrocarbon that is visible in the emissions. While the motor emits carbon monoxide continuously as it runs, the warm-up period when carbon monoxide concentration rises is always discernible by the operator who sees visible smoke.

Hydrocarbons suitable for such smoke creation are known in the production of theatrical effects where a localized opaque mist is generated. Such hydrocarbons are called fogging oils.

The method is applicable for suppressing infestations of insects.

Another aspect of the disclosure provides an apparatus for destruction of air-breathing vermin comprising an internal combustion engine with an exhaust system operable to direct a stream of exhaust gas into a treatment site and a carbonation device operable to mix air with hydrocarbon gas in the working mode and to optionally admit a fuel component that gives a visible indication of emissions in the warm-up mode.

Motors of 100 cc to 400 cc capacity, running at speeds of 400 rpm to 3000 rpm, are useful for mobile work. Flows of 400 liters/minute are required for fumigating the burrows of small animals.

The danger present in operating such apparatus in the confined space, such as a grain silo or a single-story storage building, is that the emissions are invisible, being a mixture of oxides of nitrogen carbon dioxide and any unburnt fuel. These are lethal to the operator. Normally, the motor is audible when running, but if the operator's hearing is impaired or there is competing noise such as refrigeration, air-conditioning, agricultural machinery or vehicle noise, the operator may not hear the motor and breathe in the emissions.

The apparatus may have, in addition to a replenishable gas supply, a reservoir for fuel additive and a valve for selectively admitting the additive to the engine.

The valve may be a two-way tap.

### Advantageous Effects of Disclosure

1. Mobile treatment apparatus provides easy access to sites in the field.

2. The visible smoke gives ample prior warning to the operators of the presence of lethal gas.

3. The humane treatment of the target pests is evident.

### BRIEF DESCRIPTION OF THE DRAWINGS

One embodiment of the disclosure is now described with reference to the accompanying drawings, in which:

FIG. 1 is a diagrammatic side view of a single wheel barrow with apparatus for delivering exhaust emissions into a burrow.

FIG. 2 is a diagram of the two extra entry positions for optionally admitting the extra fuel component to the inlet of the engine.

FIG. 3 is a diagram of a larger scale trailer version of the apparatus for fumigating silos.

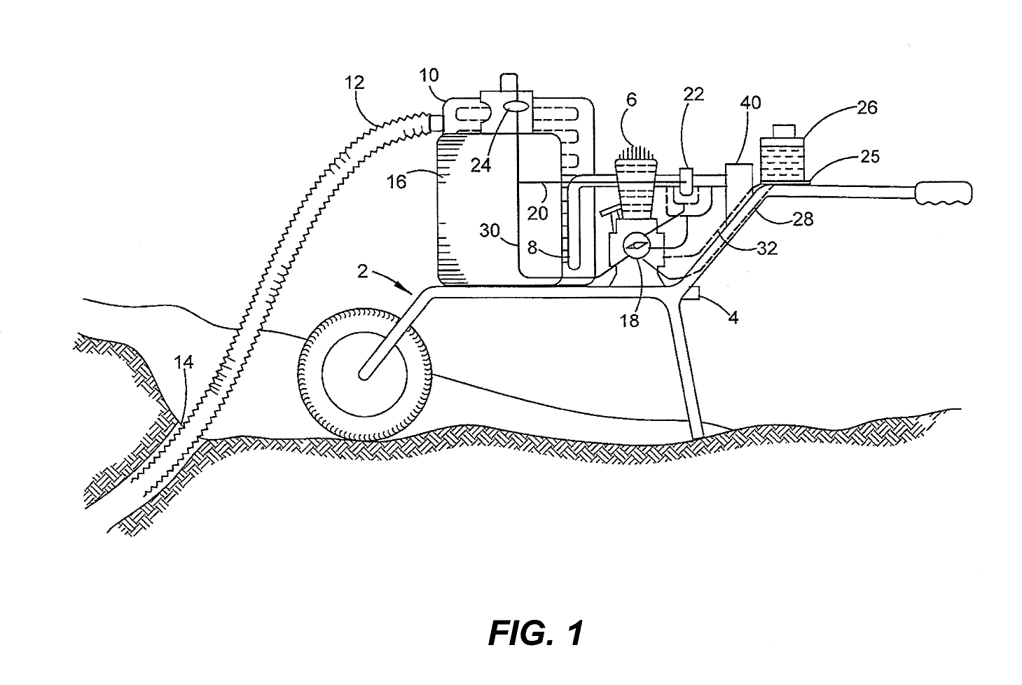

### DETAILED DESCRIPTION

Referring to the drawings, barrow 2 supports baseboard 4 to which is bolted a 100 cc 4-stroke air-cooled motor 6. The motor exhaust 8 discharges into metal heat exchanger 10 of a large surface area, which is also air cooled, the purpose being to reduce the pressure and temperature of the emissions before they leave through flexible hose 12. Hose 12 is about 40 mm in diameter and inserts into burrow 14. A plug of suitable size is pushed into the burrow entrance to surround the hose. Gas bottle 16 connects to valve 18, which conducts the LPG fuel through pipe 20 to the gas/air mixer 22. Bottle pressure is lowered by reducing valve 24 so that the motor runs at 3000 rpm to 3600 rpm during fumigation. This generates a flow of 450 liters/minute.

Support 25 is for fogging oil container 26, which connects to valve 18 via tube 28. Extra fuel gas reaches the engine manifold through branch tube 30.

Valve 18 has two inlet ports, one for fuel gas and one for fogging oil from container 26, and two outlet ports, one for fogging oil and the other for extra fuel needed for fumigation. The valve 18 has a START position in which lean fuel sufficient to start the engine flows through pipe 20 directly to the gas/air mixer 22. The valve 18 also has a RUN position in which fogging oil is admitted to mixer 22 via tube 28 and extra fuel reaches the manifold through branch tube 30.

Tank or fogging oil container 26 contains a float, the purpose of which is to interrupt a safety circuit 32 when the oil level needs replenishing. The absence of oil allows the float to descend and connect the ignition coil to earth, thereby preventing the RUN condition. Therefore, the motor will not run if the fogging oil tank 26 is empty.

Once the apparatus is at the site and a subterranean passage of the burrow is accessible, valve 18 is turned to the START position, the motor is pull started and allowed to run on a lean supply of LPG for two minutes. The hose 12 is inserted into the burrow 14. Valve 18 is operated to mix the fogging oil with the LPG. The emissions become smoky and visible and the operator watches for smoke escape close by to indicate whether the burrow has more than one entrance as the subterranean passage network air is being displaced and replaced with exhaust emissions. The entrance to burrow 14 is covered. Exposure to about 8% carbon monoxide is fatal to small mammals such as rabbits, ground hogs and badgers.

The valve 18 is operated to cancel the fogging oil and the motor continues to run for two minutes to expose any animals to a lethal dose of carbon monoxide. Rabbits and rats are observed to settle and appear to fall asleep after about 60 seconds when breathing the emissions. The motor is stopped, the motor cools, the hose removed and the barrow is taken to the next site.

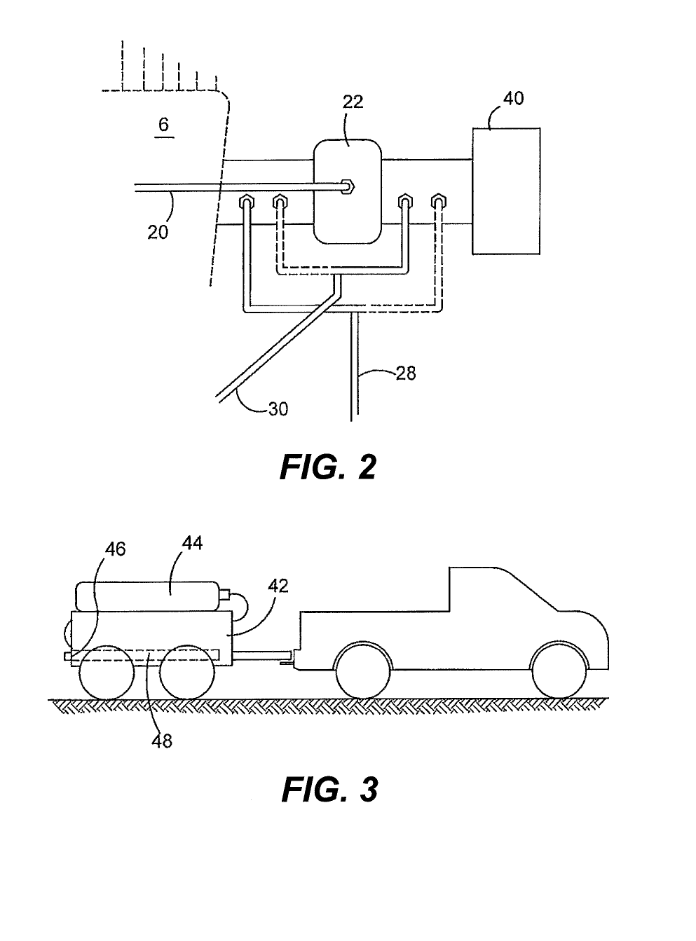

Motor 6 in FIG. 2 receives a lean fuel supply through pipe 20. The extra fuel for enriching the carbon content of the emissions to 8% can be added by branch tube 30 at either of the positions shown in broken lines. Fogging oil reaches the intake through tube 28 at either of the positions indicated. Filter 40 is standard.

When the fumigator is supplied as a road-going version for visits to silos or euthanizing chambers, the apparatus is built as a trailer 42 as shown in FIG. 3. The motor is a multi-cylinder engine of several liters in capacity with electric starting. The exhaust emissions are piped into the silo or chamber, which are vented to show the operator that the contained air is being replaced with fumigating emissions. A silo would be fumigated after any fresh addition of storage material. This is because rats, mice and weevils may thereby be introduced. LPG cylinder 44 is of large capacity. Emissions leave via outlet 46. Coiled hose is stored in the trailer. An air dryer 48 connected between the motor exhaust and outlet 46 removes water vapor from the emissions to prevent increase in silo moisture during fumigation.

It is to be understood that the word “comprising” as used throughout the specification is to be interpreted in its inclusive form, i.e., use of the word “comprising” does not exclude the addition of other elements.

It is to be understood that various modifications of and/or additions to the disclosure can be made without departing from the basic nature of the disclosure. These modifications and/or additions are, therefore, considered to fall within the scope of the disclosure.

1. Mobile apparatus for the destruction of air-breathing vermin comprising a trolley, an internal combustion engine supported on the trolley with an exhaust system operable to direct a stream of engine exhaust gas into a treatment site, a hydrocarbon fuel reservoir, a conduit for connecting the system to the treatment site and a carbonation device which increases the oxides of carbon content in the exhaust gases by adding hydrocarbon fuel beyond the level required to run the engine.

2. Mobile apparatus as claimed in claim 1, wherein the carbonation device adds fuel to raise the oxides of carbon content in the exhaust gas to at least 5%.

3. Mobile apparatus as claimed in claim 2, wherein the carbonation device adds fuel to raise the oxides of carbon content in the exhaust gas to 6-9%.

4. Mobile apparatus as claimed in any one of claims 1-3, having also an oil reservoir for a fuel additive and a valve for selectively admitting the additive to the engine.

5. Mobile apparatus as claimed in claim 4, wherein the valve is a two way tap.

6. Mobile apparatus as claimed in any one of claims 1-5, wherein a heat exchanger in series with the engine exhaust cools the exhaust gas before admission to the site.

7. Mobile apparatus as claimed in any one of claims 1-6, wherein the fuel reservoir is a portable gas tank for liquefied hydrocarbon gas.

8. Mobile apparatus as claimed in any one of claims 4-7, wherein the fuel additive is a fogging oil.

9. Mobile apparatus as claimed in claim 7 or 8, wherein a pressure reducing valve is interposed between gas tank and the engine intake.

10. Mobile apparatus as claimed in any one of claims 1-9, wherein the engine is a single cylinder 100-400 ml capacity capable of exhaust flows of at least 460 l/min.

11. Mobile apparatus as claimed in any one of claims 1-10, wherein the trolley has handles which fold to overlie the engine.

12. Mobile apparatus as claimed in any one of claims 1-9, wherein the engine is a multi-cylinder engine and the trolley is towable by a road vehicle for moving from site to site.

13. Mobile apparatus as claimed in any one of claims 4-12, wherein the engine has a hydrocarbon fuel gas inlet in the engine intake in addition to the fuel inlet to the carburetor.

14. Mobile apparatus as claimed in claim 13, wherein the inlet is upstream or downstream of the carburetor.

15. Method apparatus as claimed in claim 13 or 14, wherein both inlets receive fuel from the same valve.

16. Method apparatus as claimed in any one of claims 4-15, wherein the fogging oil tank has an oil detector which opens engine ignition contact when absence of oil is detected.

17. A method of euthanizing air-breathing vermin in a confined site by introduction into their air supply of exhaust gases from an engine in which the oxides of carbon content has been raised to at least 5%.

18. A method claimed in claim 17, wherein the exhaust gases are introduced into the confined site at at least 5 psi.

19. A method as claimed in claim 17 or 18, wherein the exhaust gases are rendered visible by the inclusion of a fogging oil in the engine fuel or with a hot part of the exhaust system.

20. A method of poisoning insects in a chamber by displacing the air in the chamber with exhaust gases from an engine in which the oxides of carbon content has been raised to at least 5%.

21. A method as claimed in claim 20, wherein the chamber is a grain silo.
